(19) United States
(12) Patent Application Publication
(10) Pub. No.: US 2013/0124310 A1
(43) Pub. Date: May 16, 2013

(54) METHOD AND APPARATUS FOR CREATING RECOMMENDATIONS FOR A USER

(71) Applicants: Mauro Barbieri, Einhoven (NL); Serverius Petrus Paulus Pronk, Eindhoven (NL); Johannes Henricus Maria Korst, Eindhoven (NL)

(72) Inventors: Mauro Barbieri, Einhoven (NL); Serverius Petrus Paulus Pronk, Eindhoven (NL); Johannes Henricus Maria Korst, Eindhoven (NL)

(73) Assignee: KONINKLIJKE PHILIPS ELECTRONICS N.V., EINDHOVEN (NL)

(21) Appl. No.: 13/810,307

(22) PCT Filed: Jul. 14, 2011
(86) PCT No.: PCT/IB11/53139

§ 371 Date: Jan. 15, 2013

(30) Foreign Application Priority Data
Jul. 20, 2010 (EP) 10170097.9

(51) Int. Cl. G06Q 30/06

(52) U.S. Cl. CPC G06Q 30/0631
USPC 705/14.49; 705/26.7

(57) ABSTRACT

A method and apparatus for creating recommendations for a user is described. A user input relating to an item is received (step 200). A hierarchy of categories is determined from the metadata of the item (step 204). A rating of at least one category within any one level of the hierarchy is received (step 208). Recommendations for the user are created based on at least the received rating of the at least one category (step 210).

### FIELD OF THE INVENTION

The present invention relates to a method and apparatus for creating recommendations for a user.

### BACKGROUND OF THE INVENTION

Broadcasters, web services, software providers, etc, allow users access to free content but, at the same time, expose users to commercial advertisements since advertising is their main source of revenue. For example, TV broadcasters offer free TV content to attract viewers but sell advertisement space to advertisers for inserting commercial advertisements between the TV content. Similarly, many web sites offer free services (e.g. Internet searches) to attract visitors to their website but sell space for commercial advertisements in the form of graphical, animated banners or ‘sponsored links’.

Although some advertisements may appeal to users, most of the advertisements are annoying for a user, particularly if the user is not interested in the products or services being advertised. The user is mostly interested in the service or content being provided and does not want their experience to be disrupted by advertisements. Users want to feel in control, and in the case of advertisements being automatically placed within or around other content (e.g. web pages, personal TV channels, a user interface, etc), the user likes to have the possibility of not watching the advertisements or even removing the advertisements if he is not interested in them.

To deal with this, some systems make advertisements more acceptable to the user by targeting the advertisements to this user based on his behavior, his preferences (for example, preferred artist or a movie genre) and, more importantly, to the context in which the advertisements are placed. For example, some systems use keywords, domain names, topics, and demographic targets, etc, specified in a user profile to only place advertisements on websites and web pages containing content that is relevant to the user and, also, to choose advertisements having content that will be of interest to the user (for example, because the content is listed in the user profile or is rated highly in the user profile).

US 2002/0152463 discloses a system for providing preferred programming events to a user, based on a combination of goodness-of-fit scores associated with categories of a classification hierarchy and a user profile that includes preference scores associated with categories of the classification hierarchy. However, although systems such as this are able to provide advertisements to a user that are more likely to be relevant and of interest to the user, there is no guarantee that the system will not render advertisements to the user that the user dislikes or is of no interest to them because a user profile only generally lists content that is liked by a user.

In some systems, this is overcome by allowing a user the option to remove a current advertisement, provide an indication that a current advertisement is disliked or to give a poor rating (typically on a two, a five, or a ten star rating scale) to a current advertisement. When a user carries out one of these options, the system blacklists the current advertisement to prevent it from being rendered to the user in the future and adapts the user profile so that the chance of another advertisement that is similar to the current advertisement being rendered to the user is lower. However, this does not guarantee that advertisements similar to the removed/disliked/poorly rated advertisement will not be rendered to the user in the future because the placement of advertisements depends on a various factors, which the user can only indirectly control. In fact, the system would require many more negative ratings of other advertisements that are similar to the current advertisement before the system can produce useful recommendations. This means that the user is required to repeatedly indicate to the system that they are not interested in an advertisement and the system requires a relatively high number of ratings before it can produce useful recommendations, which can be frustrating for the user.

Furthermore, although this system allows a user to cease a current advertisement from being rendered, it is difficult for the system to interpret the reasons behind the user making this choice. For example, the user may not be interested in the particular product that is the subject of the advertisement (e.g. beer or, more particularly, Heineken beer), the user may not be interested in the particular advertisement, the user may have already seen the advertisement, or the user may not be interested in the entire category of products relating to the subject of the advertisement (e.g. all advertisements about alcoholic beverages or beverages in general). Without further insights into the reasons behind the removal of the advertisement by the user, the system cannot effectively learn from the actions of the user and the recommendations for a user therefore cannot be improved.

### SUMMARY OF THE INVENTION

The invention seeks to provide a method and apparatus that provides an insight into the reasons behind the removal/indication of dislike/poor rating provided by a user regarding an item in order to improve the relevancy of the recommendations provided to the user.

This is achieved, according to an aspect of the invention, by a method for creating recommendations for a user, the method comprising the steps of: receiving a user input relating to an item; determining, from the metadata of the item, a hierarchy of categories; receiving a rating of at least one category within any one level of the hierarchy; and creating recommendations for the user based on at least the received rating of the at least one category.

This is achieved, according to another aspect of the invention, by an apparatus for creating recommendations for a user, the apparatus comprising: a user interface for receiving a user input relating to an item; a processor for determining, from the metadata of the item, a hierarchy of categories; the user interface for receiving a rating of at least one category within any one level of the hierarchy; and a recommender for creating recommendations for a user based on at least the received rating of the at least one category.

In this way, the user can rate not only the individual item, but any category of the hierarchy, thereby providing the user with an enhanced feeling of control. Moreover, the user can quickly indicate his preferences for entire categories of similar items, thereby providing an insight into the reasons behind the removal, indication of dislike, or poor rating of an item provided to the user. This improves the relevancy of the recommendations provided to the user so that the user is required to rate fewer items before the apparatus can generate useful recommendations.

The step of determining, from the metadata of the item, a hierarchy of categories may comprise dynamically determining, from the metadata of the item, a hierarchy of categories. In this way, smaller hierarchies related to a single item that include categories that the user actually likes can be created.

The method may further comprise the step of rendering the determined hierarchy of categories to the user. In this way, the user is able to intuitively navigate the categories to input his ratings regarding one or more of the categories.

The method may further comprise the step of rendering at least one recommendation to the user based on the created recommendations. In this way, the user is provided with recommendations that will be relevant or of interest to him.

The step of creating recommendations for a user, based on at least the received rating of the at least one category may comprise updating a user profile and/or updating a blacklist based on the received rating of the at least one category. In this way, the apparatus has a record relating to the inputs received for items and can therefore create more relevant recommendations in the future.

The user input may include at least one of an indication that the user likes or dislikes the item, a value from a rating scale of degrees of likeness for the item, an instruction to delete the item, an instruction to remove the item. In this way, the user has more control over how to indicate their preferences of items.

The step of determining, from the metadata of the item, a hierarchy of categories may comprise determining, from the metadata of the item, a plurality of hierarchies of categories, and combining the plurality of hierarchies to determine the hierarchy. In this way, a hierarchy is determined for each feature (e.g. genre) of the item whose values (e.g. main genre, sub-genre, and sub-sub-genre) can be represented in a hierarchical way. This means that a user is able to indicate the exact features relating to the item that are disliked, which will further improve the relevancy of any recommendations that are provided to the user.

The item may be one of a webpage, a television program, an advert, an image, a video, or an audio file. The apparatus can therefore be used in many applications.

### BRIEF DESCRIPTION OF THE DRAWINGS

For a better understanding of the invention, and to show more clearly how it may be carried into effect, reference will now be made, by way of example only, to the accompanying drawings in which:

FIG. 1 is a simplified schematic of an apparatus for creating recommendations for a user according to the invention; and

FIG. 2 is a flowchart of a method for creating recommendations for a user according to the invention.

### DETAILED DESCRIPTION

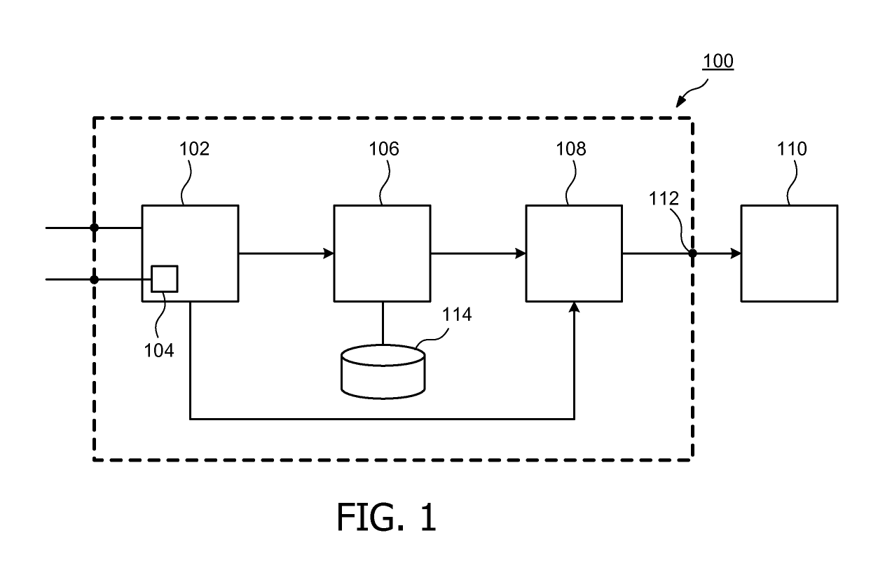

With reference to FIG. 1, the apparatus 100 comprises a user interface 102 for receiving a user input relating to an item. The user interface 102 may be integrated in the apparatus 100 (as shown) or may be separate from the apparatus 100 and wirelessly connected to or wired to the apparatus 100. The output of the user interface 102 is connected to a processor 106 and to a recommender 108. The output of the processor 106 is connected to a recommender 108. The recommender 108 may be wirelessly connected to or wired to an external device 110 via an output channel 112. Alternatively, the apparatus 100 may be integrated in the external device 110. The external device 110 may be, for example, a TV, a stereo, a computer, a screen, or the like, or a mobile device such as a mobile terminal, a portable TV, or the like. The user interface 102 may comprise a rendering device 104 for rendering recommendations to a user. Alternatively, the processor 106 may control the external device 110 to render recommendations to a user. The processor 106 is connected to a storage device 114.

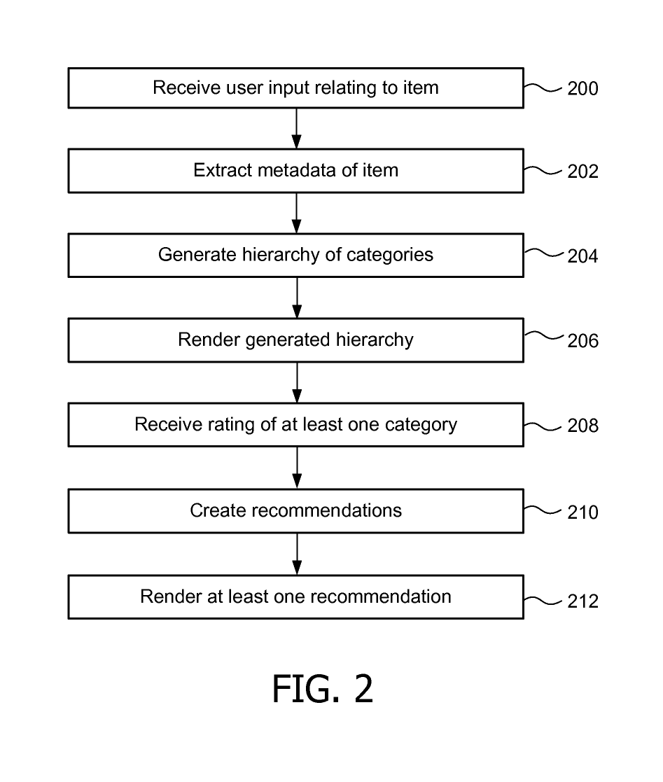

The operation of the apparatus 100 will now be described with reference to the flowchart shown in FIG. 2.

The user interface 102 receives a user input relating to an item (step 200). The item may be, for example, a webpage, a television program, an advert, an image, a video, an audio file, or the like. The user input received by the user interface 102 includes at least one of an indication that the user likes or dislikes the item, a value from a rating scale of degrees of likeness for the item, an instruction to delete/remove the item.

The user interface 102 communicates the user input to the processor 106 and upon receiving the user input, the processor 106 extracts the metadata of the item to which the user input relates (step 202). The item and the metadata of the item are stored in a storage device 114. The processor 106 determines a hierarchy of categories from the metadata of the item (step 204). The processor 106 may control the storage device 114 to store the determined hierarchy of categories.

The processor 106 may determine the hierarchy of categories from the metadata of the item. This may involve consulting a local or remote database storing an electronic ontology. For example, the processor 106 may determine the hierarchy using categories associated with the features of the advertisement to create a sub-hierarchy (effectively a structured subset of features), so that the hierarchy shows the categories themselves (e.g. beer), categories in the same level of the hierarchy (e.g. wine, spirits, etc) and categories from higher levels in the hierarchy (alcoholic beverages, beverages, etc) and/or lower levels in the hierarchy (e.g. Heineken beer). The creation of the hierarchy by the processor 106 can be made dynamic by, for example, not showing parts of the hierarchy that the user has sufficiently down-rated. For example, if the user has indicated that he dislikes wine a certain number of times or if wine has received a rating lower than a predetermined value, wine will no longer be shown in the hierarchy. In this way, ratings received on previously created hierarchies can be used to create smaller hierarchies related to a single item that include categories that the user actually likes.

The processor 106 may also determine a plurality of hierarchies of categories from the metadata of the item and combine the plurality of hierarchies to determine the hierarchy. In this way, the hierarchy is actually a combination of multiple hierarchies, one for each feature of the item whose values can be represented in a hierarchical way. For example, in the case of video advertisements, the feature “genre” can be represented as a hierarchy that includes the values: main genre, sub-genre, and sub-sub-genre. Furthermore, an item may have multiple genres, each having its own hierarchy. For example, a user may not like advertisements with too much action or the like.

The processor 106 inputs the hierarchy of categories into the recommender 108.

The processor 106 also inputs the determined hierarchy of categories into the rendering device 104 of the user interface 102 and the rendering device 104 renders the determined hierarchy of categories to the user (step 206). For example, the rendering device 104 may be a display that displays the determined hierarchy of categories to the user or the rendering device 104 may be an audio device that outputs the hierarchy of categories to the user in the form of audio. Alternatively, the processor 106 may control the external device 110 to render the hierarchy to a user.

The user interface 102 receives a rating from the user of at least one category within any one level of the hierarchy (step 208) and inputs the rating into the recommender 108. The rating may be stored in the storage device 114.

The recommender 108 creates recommendations for the user based on the received rating of the at least one category (step 210). The rating may include at least one of an indication that the user likes or dislikes the category, and a value from a rating scale of degrees of likeness for the category. The recommender 108 may, for example, update a user profile and/or update a blacklist based on the received rating of the at least one category. For example, if the user interface 102 receives a rating of a category that is an indication that the user dislikes the category or that is a value from a rating scale of degrees of likeness for the category that is below a predetermined value, the recommender 108 adds the category to a blacklist so that items relating to that category are no longer rendered to the user. Similarly, if the user interface 102 receives a rating of a category that is an indication that the user likes the category or that is a value from a rating scale of degrees of likeness for the category that is above a predetermined value, the recommender 108 updates a user profile to place the category higher in the list of preferences of the user. The updated user profile and blacklist can then be used by the recommender 108 to predict ratings for new items. The user profile and blacklist may be stored in the storage device 114.

The recommender 108 outputs the created recommendations into the rendering device 104, which renders at least one recommendation to the user based on the created recommendations (step 212). Alternatively, the recommender 108 outputs the created recommendations to the external device 110 via the output channel 112 and controls the external device 110 to render at least one recommendation to the user based on the created recommendations.

Where the external device 110 is a TV, the apparatus 100 can be used to automatically insert targeted advertisements between programs.

A specific embodiment will now be described where the external device 110 is a TV having a personal channel. The personal channel has five programs P1-P5 and two automatically placed advertisements A1 and A2. The advertisements A1 and A2 are placed between the programs P1-P5 as follows:

| | | | | | | |
|---|---|---|---|---|---|---|
| P1 | P2 | A1 | P3 | P4 | A2 | P5 |

In this example, A1 is an advertisement from “Heineken” and relates to a new beer. Also, the user in this example does not like beer in general, including Heineken beer.

When the user views the Heineken beer advertisement A1, the user interface 102 receives a negative rating relating to the advertisement A1 (step 200).

The processor 106 extracts the metadata of the advertisement A1 (step 202) and determines a hierarchy of categories from the extracted metadata (step 204).

The rendering device 104 renders the determined hierarchy of categories to the user (step 206). For example, the rendering device 104 presents the hierarchy of categories to the user in the form of a graphical representation, as shown below:
Food & beverages
Beverages
Alcoholic beverages
Beer
Heineken beer

The user can then give a positive or negative rating at any level of the presented hierarchy via the user interface (step 208). In this way, the user could give a negative rating to “beer” and “Heineken beer” but a positive rating to the other levels if, for example, the user likes wine and would not mind seeing advertisements related to wine products.

Additionally, the user is able to select, for each level of the hierarchy, other values for the feature and the particular level. For example, at the second level of the hierarchy “beer”, the user is able select other values such as “wine”, “liquor”, etc, that belong to the upper level “alcoholic beverages” and is able to rate these other values independently.

After the user has indicated at which level of the hierarchy the rating applies, the recommender 108 can create recommendations for the user based on the received rating (step 210) including safely deciding which advertisements should not be shown in the channel in the future.

The apparatus 100 described herein can be applied to TV sets, personal video recorders (PVRs), set-top boxes, audio systems (including portable audio), services (including Internet video and music services) and any other system where recommendations are used. In addition, the apparatus 100 can be applied in many content-based and context-based advertising systems, such as web advertising.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for creating recommendations for a user, the method comprising:
receiving a user input relating to an item;
determining, from the metadata of the item, a hierarchy of categories;
receiving a rating of at least one category within any one level of the hierarchy; and
creating recommendations for the user based on at least the received rating of the at least one category.

2. The method according to claim 1, wherein the determining, comprises dynamically determining, from the metadata of the item, a hierarchy of categories.

3. The method according to claim 1, further comprising rendering the determined hierarchy of categories to the user.

4. The method according to claim 1, further comprising rendering at least one recommendation to the user based on the created recommendations.

5. The method according to claim 1, wherein the creating comprises updating a user profile and/or updating a blacklist based on the received rating of the at least one category.

6. The method according to claim 1, wherein the user input includes at least one of an indication that the user likes or dislikes the item, a value from a rating scale of degrees of likeness for the item, an instruction to delete the item, and an instruction to remove the item.

7. The method according to claim 1, wherein the determining comprises determining, from the metadata of the item, a plurality of hierarchies of categories, and combining the plurality of hierarchies to determine the hierarchy.

8. The method according to claim 1, wherein the item is one of a webpage, a television program, an advert, an image, a video, and an audio file.

9. A non-transitory computer program product comprising a plurality of program code portions for carrying out the method according to claim 1.

10. Apparatus for creating recommendations for a user, the apparatus comprising:
a user interface for receiving a user input relating to an item;
a processor for determining, from the metadata of the item, a hierarchy of categories;
a user interfaced for receiving a rating of at least one category within any one level of the hierarchy; and
a recommender for creating recommendations for the user based on at least the received rating of the at least one category.

11. Apparatus according to claim 10, the apparatus further comprising a rendering device for rendering the determined hierarchy of categories to the user.

12. The method according to claim 1, further comprising:
rendering the item;
receiving said user input relating to the item upon rendering the item;
determining the hierarchy upon receiving the user input relating to the item;
rendering the determined hierarchy of categories to the user; and
receiving the rating from the user via a user interface.

13. The method according to claim 1, comprising automatically inserting targeted advertisements between programs rendered on a TV using the recommendations.

14. The method according to claim 1, further comprising:
rendering the item on the TV;
receiving said user input when the user views the item on the TV;
determining the hierarchy upon receiving the user input relating to the item;
presenting the hierarchy of categories to the user in the form of a graphical representation;
receiving the rating at any level of the presented hierarchy via a user interface; and
deciding which advertisements will not be inserted in a TV channel in the future based on the received rating.
